(19) United States
(12) Patent Application Publication
(10) Pub. No.: US 2002/0096849 A1
(43) Pub. Date: Jul. 25, 2002

(54) Trick bar for foot scooter

(76) Inventor: Richard Michael Bang, Pacific Palisades, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/872,260

(22) Filed: Jun. 1, 2001

Related U.S. Application Data
(60) Provisional application No. 60/262,734, filed on Jan. 19, 2001.

(51) Int. Cl. A63C 11/00; B62M 1/00

(52) U.S. Cl. 280/87.041; 280/809

(57) ABSTRACT

A trick bar for a foot scooter including a pair of generally parallel elongated support arms having first ends thereof attached to a rear end of the foot scooter. A foot bar extends across second ends of the support arms. A wheel is supported intermediate the first and second ends of the support arms so as to rest a distance above the ground on which the foot scooter rests. The wheel is rotatable about an axle that extends across the support arms intermediate the first and second ends thereof. Upon application of downward pressure on the foot bar, a front end of the foot scooter raises off the ground and the trick bar wheel contacts the ground to permit the rider of the scooter to perform tricks. The support arms are preferably pivotally attached to the foot scooter so as to be folded over the foot scooter during non-use.

### RELATED APPLICATION

This application claims priority from provisional application Serial No. 60/262,734, filed Jan. 19, 2001.

### BACKGROUND OF THE INVENTION

The present invention relates generally to toy foot scooters. More particularly, the present invention relates to a trick bar for use on such foot scooters.

Foot scooters are devices which include a foot platform having a pair of in-line wheels for moving the platform, and a post extending upwardly from one end of the platform for the attachment of hand grips which aid the user in maneuvering the foot scooter device. Recently, such foot scooters have had a tremendous market impact. They are particularly attractive amongst children and teenagers. As these scooters have become popular, many suppliers have begun to introduce various accessories for the foot scooters, including flashing wheels, shoulder straps, etc.

A particular company recently came out with an accessory item called the “wheelie bar”, which is designed to fit or attach to the rear end of the scooter for the rider to step on as he or she wishes to conduct or perform tricks while riding the scooter. However, this “wheelie bar” has been found to be limited in its use due to several design flaws. The accessory has insufficient body length which triggers unwanted or unplanned braking of the scooter as the foot often applies force to the bar and brake covering the rear wheel simultaneously. Also, the number of tricks that can be performed using the accessory are limited as there is a very limited time of suspension of the front wheel prior to a complete stop, unless the rider is extremely proficient. Moreover, the accessory has a limited application as it has been designed to be attached to only one particular brand of foot scooter.

Accordingly, there is a need for a trick bar accessory which can be attached to any number of foot scooters. What is also needed is such a trick bar accessory which increases the amount of time the front wheel is suspended, while enabling the rider to perform more tricks without unwanted or unplanned braking of the foot scooter. The present invention fulfills these needs and provides other related advantages.

### SUMMARY OF THE INVENTION

The present invention resides in a trick bar or a foot scooter which enables the rider to perform tricks without unwanted or unplanned braking of the foot scooter, and which also enables the front end of the foot scooter to be raised to differing heights. The trick bar generally comprises a pair of parallel elongated support arms each having a first end attached to a rear end of the foot scooter, and an elevated second end. A foot bar extends across the second ends of the support arms. A wheel is supported by the support arms intermediate the first and second ends thereof so as to rest a distance above the ground on which the foot scooter rests. Upon application of downward pressure on the foot bar, a front end of the foot scooter raises off the ground and the trick bar wheel contacts the ground to permit the rider to perform tricks.

The support arms are generally curved in configuration, and typically pivotally attach to the foot scooter so as to be folded over the foot scooter. Each support arm includes a stop that is configured to contact the foot scooter in order to limit the downward pivoting range of the support arms, particularly during use of the trick bar.

The wheel is rotatable about an axle which extends across the support arms intermediate the first and second ends thereof. The axle is configured so as to be removable from the support arms for changing the wheel with replacement wheels which may differ in size. The axle may support a wheel which is positioned between the support arms, or extend beyond the support arms and support two wheels positioned without the support arms.

The support arms typically include a series of apertures which permit the axle to be moved between positions along the support arms, which affects the front wheel lift of the foot scooter when tricks are performed. The support arms include reinforcement areas substantially surrounding the axle to accommodate the forces concentrated around the axle while tricks are performed.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawing illustrates the invention. In such drawing:

FIG. 1 is a perspective view of a trick bar embodying the present invention, and having two wheels rotatably mounted on an axle outside support arms of the trick bar;

FIG. 2 is a perspective view of a trick bar of FIG. 1, having a single wheel rotatably mounted on an axle within the support arms;

FIG. 3 is a perspective view of the trick bar of FIG. 1, having a single small wheel mounted on the axle in between the support arms;

FIG. 4 is a partially fragmented elevational view of a foot scooter having the trick bar of FIG. 1, attached to a rear end thereof;

FIG. 5 is an elevational view similar to FIG. 4, with the front end of the foot scooter being elevated off the ground, and the wheels of the trick bar in contact with the ground;

FIG. 6 is an elevational view similar to FIGS. 4 and 5, wherein the wheels of the trick bar have been repositioned so the front end of the foot scooter is lifted to a lesser degree than that of FIG. 5;

FIG. 7 is a partially fragmented elevational view of a foot scooter having the trick bar of FIG. 2, attached to a rear end thereof;

FIG. 8 is an elevational view similar to FIG. 7, illustrating the front end of the foot scooter lifted from the ground and the wheel of the trick bar in contact with the ground;

FIG. 9 is an elevational view similar to FIGS. 7 and 8, wherein the wheel has been repositioned in order to allow the front end of the scooter to be lifted to a greater degree than that of FIG. 8;

FIG. 10 is a partially fragmented elevational view of a foot scooter resting on the ground and having the trick bar of FIG. 3 attached to a rear end thereof;

FIG. 11 is an elevational view similar to FIG. 10, illustrating the front end of the foot scooter lifted off of the ground, and the wheel of the trick bar in contact with the ground;

FIG. 12 is an elevational view similar to FIGS. 10 and 11, wherein the wheel has been repositioned to permit the front end of the foot scooter to be raised to a greater degree than that of FIG. 11;

FIG. 13 is an elevational view of the trick bar of FIG. 2 attached to a rear wheel axle of a foot scooter;

FIG. 14 is a partial cross-sectional view taken general along line 14-14 of FIG. 13, illustrating inwardly directed flanges of the support arms in contact with a frame of the foot scooter;

FIG. 15 is an elevational view of a foot scooter having a trick bar embodying the present invention attached thereto, illustrating the compacting of a front end of the foot scooter, and the folding over of the trick bar onto the foot scooter for transport and storage.

### DETAILED DESCRIPTION OF THE PREFERRED EMBODIMENTS

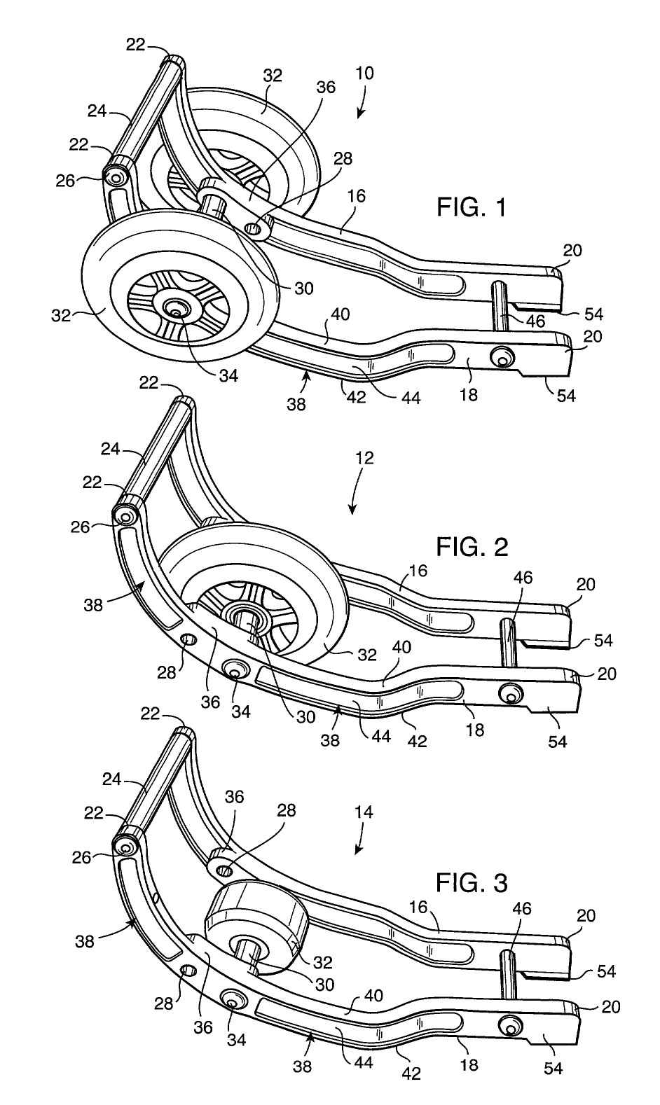

As shown in the drawings for purposes of illustration, the present invention is concerned with a trick bar for a foot scooter, generally referred to by the reference number 10 in FIGS. 1 and 4-6, and by the reference number 12 in FIGS. 2 and 7-9, and by the reference number 14 in FIGS. 3 and 10-12. In each of the illustrated embodiments, functionally equivalent components are given the same reference number.

Referring to FIGS. 1-3, the trick bars 10-14 include first and second support arms 16 and 18 having a generally curved configuration so that a first end 20 lies lower than a second end 22 of the support arms during use. The support arms 16 and 18 are placed generally parallel to one another. A foot bar 24 extends across the second ends 22 of the support arms 16 and 18. Although not limited to such, typically the foot bar 24 is interconnected between the second ends 22 of the support arms 16 and 18 by way of screws 26 threaded through apertures formed in the second ends 22 and into the foot bar 24. The foot bar 24 is placed at the elevated second ends 22 to provide lift, as will be more fully described herein.

A series of apertures 28 are formed in the support arms 16 and 18 intermediate the first and second ends 20 and 22. A wheel axle 30 is insertable into or otherwise alignable with the wheel apertures 28. As illustrated in FIG. 1, the axle 30 may extend through the apertures 28 so that a pair of wheels 32 may be placed on the axle 30 and reside without the support arms 16 and 18. Typically, the axle 30 is removable so that it can be positioned through any of the aligned apertures 28 so as to move the position of the wheels 32. Preferably, a screw 34 or the like is partially inserted into the wheel axle 30 so as to removably hold the axle 30 in place.

With reference to FIG. 2, the axle 30 may only extend between the support arms 16 and 18 and support a single wheel 32 therebetween. The axle 30 is preferably removable from the support arms 16 and 18, so as to enable the user of the trick bar 10-14 to place wheels 32 of differing sizes, as illustrated in FIG. 3, or position the axle 30 and wheels 32 at different points along the length of the support arms 16 and 18.

The support arms 16 and 18 include an area of reinforcement 36 surrounding the wheel axle apertures 28. Although this can be done in a variety of ways, typically, the support arms 16 and 18 are thicker in width around the apertures 28 to prevent structural failure due to the forces concentrated around the wheel axle 30 during use. As illustrated in the accompanied drawings, the support arms 16 and 18 themselves may be designed such that they are reinforced along a substantial length thereof. This can be done by creating an-I-beam structure along the length of the support arms 16 and 18, or strategic points thereof which are subject to the greatest amount of stress. This I-beam structure is formed by configuring the support arms 16 and 18 such that a top and bottom edge 40 and 42 are of a greater width than a central portion 44 of the support arms 16 and 18. Alternative reinforcement designs are possible as well, such as a C-shape tube, tubular support arms, or any available method and design which would adequately reinforce the support arms 16 and 18 so as to resist bending and breaking by the weight and pressure placed thereon during use.

A support axle 46 is removably inserted through apertures formed adjacent to the first ends 20 of the support arms 16 and 18. The support axle 46 extends through a rear wheel 48 of the foot scooter 50. The trick bar 10-14 extends from this point of attachment rearward from the foot scooter 50. By attaching the trick bar 10-14 of the present invention to the rear wheel 48 of the foot scooter 50, the trick bar 10-14 can be attached to any existing model of foot scooter 50. The support arms 16 and 18 are of a sufficient length to adequately remove the foot bar 24 from a foot brake 52 of the foot scooter 50, so as to prevent a rider from accidentally pressing on the foot brake 52 instead of the foot bar 24. The longer body length of the support arms 16 and 18 also allows the rider to properly level or maintain his or her balance while performing a trick. Due to the increased balance and lessened likelihood of inadvertently pressing the brake 52, the trick bar 10-14 of the present invention is safer than the presently existing trick bar. The rotatable wheel or wheels 32 positioned on the trick bar 10-14 also enable the rider to roll extra distance while performing the tricks.

Referring now to FIGS. 14 and 15, the first ends 20 of the support arms 16 and 18 include inwardly directed ledges or flanges 54 which are configured to contact a platform or frame 56 of the foot scooter 50 when the trick bar 10-14 is in its extended position for use. Thus, as pressure is applied downwardly on the foot bar 24, the ledges 54 apply pressure to the platform 56 of the foot scooter 50, facilitating the lifting of a front end 58 of the foot scooter 50, as will be described more fully herein.

Preferably, the support axle 46 is pivotally attached to the rear wheel 48 of the foot scooter 50 so that the trick bar 10-14 can be folded over and onto the foot scooter 50 for compact storage and transportation, as illustrated in FIG. 15. Typically, foot scooters 50 have a front end 58 which can be compacted and pivoted over onto the platform 56. Having the ledges 54 extend only from a bottom portion of the first ends 20 permit the trick bar 10-14 to be folded over onto a top surface of the platform 56, while providing adequate support to the trick bar 10-14 during use. Thus, the inwardly directed ledges 54 connect as a hinge. The ledges 54 also cause the trick bar 10-14 and associated wheel 32 to be raised from the ground surface that the foot scooter 50 rests upon, by providing leverage when the foot bar 24 is pressed downwardly. The fact that the inwardly directed ledges 54 extend only at the base of the support arms 16 and 18, and not at the top portion thereof, the trick bar 10-14 can be folded upon the foot scooter 50 for storage while not interfering with the folding and compactness provided by the foot scooter design itself, as illustrated in FIG. 15.

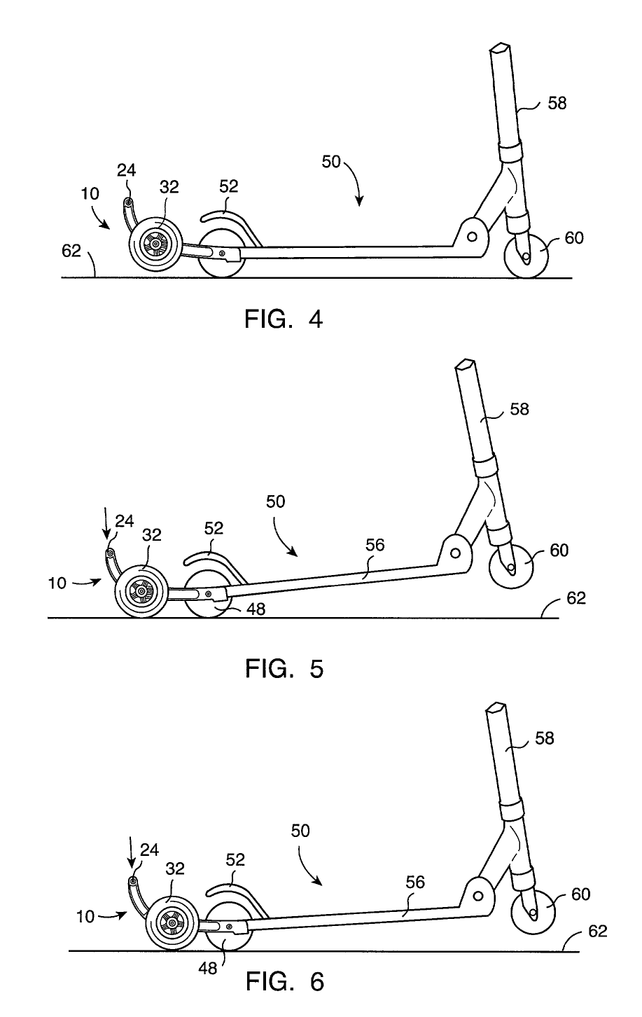

Referring now to FIGS. 4-6, a foot scooter 50 is illustrated having the trick bar 10 of FIG. 1 attached thereto. In FIG. 4, the foot scooter 50 is resting or rolling upon level ground, with the trick bar 10 elevated with respect to the ground. Upon applying downward pressure to the foot bar 24, while simultaneously pulling up the front end 58 and front wheel 60 of the foot scooter 50, the front wheel 60 rises from the ground and the wheel 32 of the trick bar 10 contacts the ground. The rider is then able to perform “wheelies”, spins, or other tricks. It will be noted by the reader that by positioning the wheels 32 at different aligned wheel apertures 28, the front end 58 of the foot scooter 50 can be increasingly or decreasingly raised from the ground 62. Thus, with the wheels 32 in the forward-most position, as illustrated in FIG. 6, the front wheel 60 of the foot scooter 50 is only allowed to rise from the ground a certain distance. However, by repositioning the wheels 32 towards the second end 22, as illustrated in FIG. 5, the front wheel 60 of the foot scooter 50 is permitted to rise a greater degree from the ground. The size of the wheels 32 attached to the trick bar 10 can also adjust the height at which the front end 58 of the foot scooter 50 will rise. For example, a larger wheel 32 will only allow the front end 58 of the foot scooter 50 to rise to a very limited degree, while a much smaller wheel placed in the same position will allow the front end 58 of the foot scooter 50 to rise higher. Thus, riders of various levels can adjust the trick bar 10-14 to meet their capabilities. Also, use of the tandem-wheel configuration trick bar 10 allows the invention to be used as a training wheel for novice scooter riders. As the wheel 32 is rotatable about axle 30, the rider is more easily allowed to continue in a forward direction while performing the tricks. Aside from permitting the rider to perform tricks which might not otherwise be possible, the additional wheel 32 presents a safety feature.

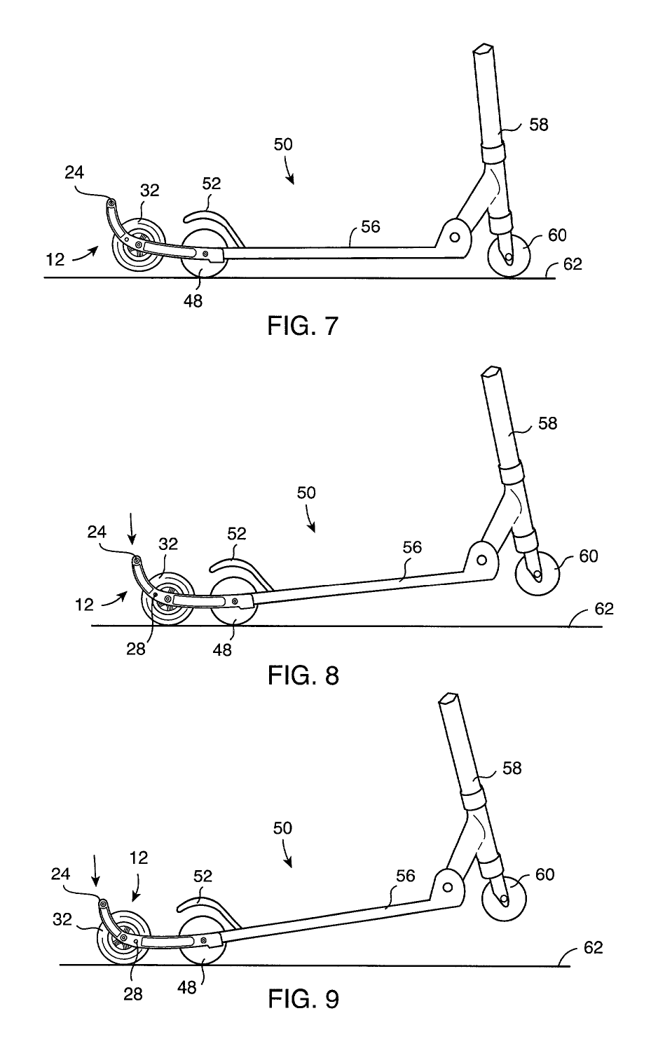

With reference to FIGS. 7-9, the same concepts described above are shown with the trick bar 12 attached to the foot scooter 50. This trick bar 12 includes a single wheel 32 positioned between the support arms 16 and 18. Such could be used for a rider of intermediate capabilities. As illustrated in FIGS. 8 and 9, by adjusting the position of the wheel 32 between aligned wheel apertures 28, the rider is allowed to control the degree that the front end 58 of the foot scooter 50 rises from the ground 62. Whereas the trick bar 10 having two wheels 32 may be cumbersome in certain tricks, the single wheel trick bar 12 permits the intermediate rider to perform additional tricks.

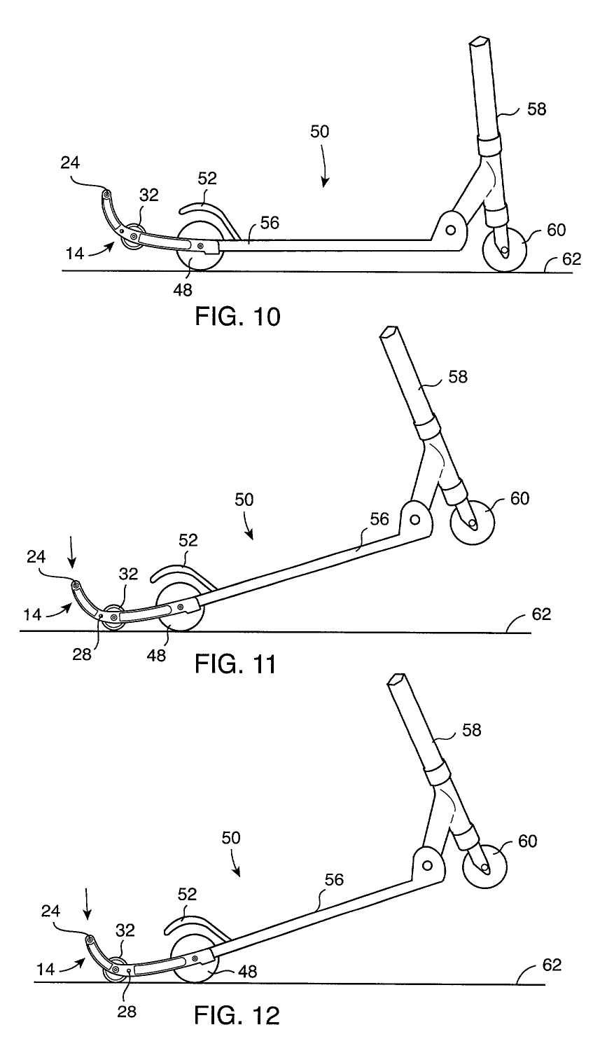

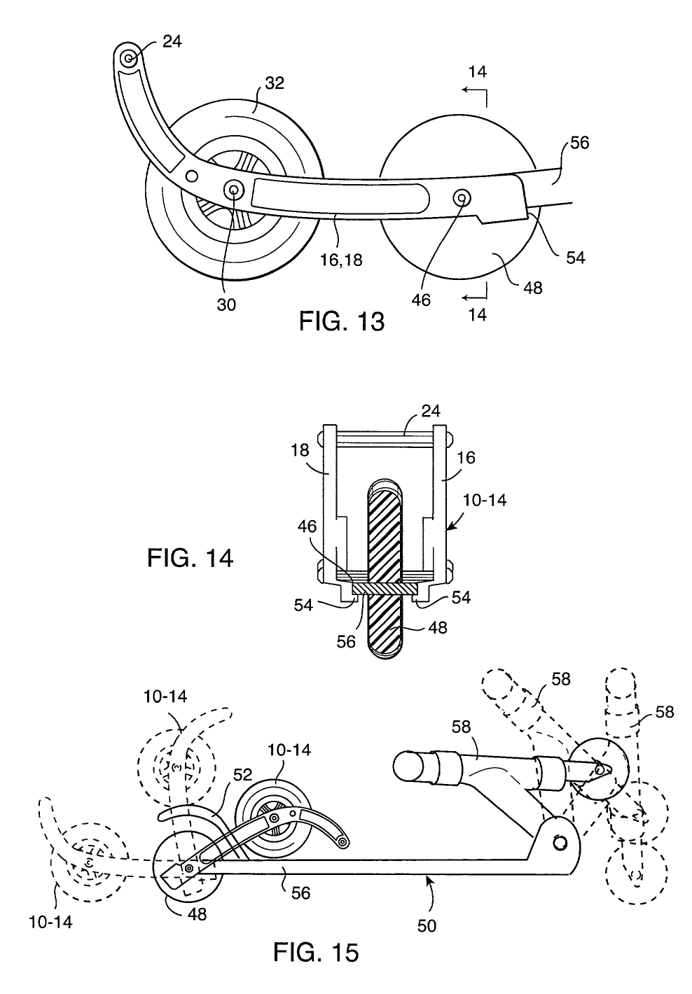

Referring now to FIGS. 10-12, the trick bar 14 of FIG. 3, is attached to the foot scooter 50. This trick bar 14 also has a single wheel 32 positioned between the support arms 16 and 18, but the wheel 32 is much smaller than the wheel of FIGS. 7-9. Therefore, an advanced rider can use this configuration to raise the front end and wheel 58 and 60 to a very large degree from the ground 62. Thus, it will be noted that the front end 58 of the foot scooter 50 is much more elevated from the ground 62 in FIG. 11, than in FIG. 8. Similarly, by positioning the wheel 32 and axle 30 and the rear most wheel apertures 28, the front end 58 of the foot scooter 50 is allowed to rise to an even greater degree, as illustrated in FIG. 12. Thus, advanced riders are enabled to perform tricks which would not otherwise be possible with other configurations.

Thus, riders of various levels can adjust the trick bar 10-14 to meet their capabilities. This is done simply by the placement, and size of the single or dual wheel configuration. The invention can thus be sold as a kit, wherein the novice scooter rider installs the longer wheel axle 30 which supports two wheels 32 outside of the support arms 16 and 18, which can then be changed for the single wheel trick bar 12 configuration illustrated in FIG. 2, and eventually the small wheel 32 configuration illustrated in FIG. 3 as the rider's capability increases. The axles 30 and wheels 32 can also be sold separately to meet the individual needs of the consumers.

Although several embodiments have been described in detail for purposes of illustration, various modifications may be made without departing from the scope and spirit of the invention. Accordingly, the invention is not to be limited, except as by the appended claims.

What is claimed is:

1. A trick bar for a foot scooter, comprising:
a pair of generally parallel elongated support arms each having a first end and an elevated second end, the first ends being attached to a rear end of the foot scooter;
a foot bar extending across the second ends of the support arms; and
a wheel supported by the support arms intermediate the first and second ends thereof so as to rest a distance above the ground on which the foot scooter rests;
whereupon downward pressure on the foot bar, a front end of the scooter raises off the ground and the wheel contacts the ground to permit a rider of the foot scooter to perform tricks.

2. The trick bar of claim 1, wherein the support arms are generally curved in configuration.

3. The trick bar of claim 1, wherein the wheel is rotatable about an axle extending across the support arms intermediate the first and second ends thereof.

4. The trick bar of claim 3, wherein the axle is configured so as to be removable from the support arms for interchanging the wheel.

5. The trick bar of claim 4, wherein the support arms include a series of apertures which permit the axle to be moved between positions along the support arms.

6. The trick bar of claim 3, wherein the support arms include reinforcement areas substantially surrounding the axle.

7. The trick bar of claim 3, wherein the axle supports a wheel positioned between the support arms.

8. The trick bar of claim 3, wherein the axle extends beyond the support arms and supports two wheels positioned without the support arms.

9. The trick bar of claim 1, wherein the support arms are pivotally attached to the foot scooter so as to be folded over the foot scooter.

10. The trick bar of claim 10, wherein each support arm includes a stop configured to contact the foot scooter so as to limit the downward pivoting range of the support arms.

11. A trick bar for a foot scooter, comprising:
a pair of generally parallel elongated support arms each support arm having a first end and an elevated second end, the first ends being attached to a rear end of the foot scooter;
a foot bar extending across the second ends of the support arms; and
an axle extending across the support arms intermediate the first and second ends thereof and rotatably supporting a wheel resting a distance above the ground on which the foot scooter rests, the axle being configured to be removable from the support arms for interchanging the wheel;
whereupon downward pressure on the foot bar, a front end of the scooter raises off the ground and the wheel contacts the ground to permit a rider of the foot scooter to perform tricks.

12. The trick bar of claim 11, wherein the support arms are generally curved in configuration.

13. The trick bar of claim 11, wherein the support arms include a series of apertures which permit the axle to be moved between positions along the support arms.

14. The trick bar of claim 11, wherein the support arms include reinforcement areas substantially surrounding the axle.

15. The trick bar of claim 11, wherein the axle supports a wheel positioned between the support arms.

16. The trick bar of claim 11, wherein the axle extends beyond the support arms and supports two wheels positioned without the support arms.

17. The trick bar of claim 11, wherein the support arms are pivotally attached to foot scooter so as to be folded over the foot scooter, and wherein each support arm includes a stop configured to contact the foot scooter so as to limit the downward pivoting range of the support arms.

18. A trick bar for a foot scooter, comprising:
a pair of generally parallel elongated support arms each having a first end and an elevated second end, the first ends being pivotally attached to a rear end of the foot scooter so as to be capable of being folded over the foot scooter, each support arm including a stop configured to contact the foot scooter so as to limit the downward pivoting range of the support arms;
a foot bar extending across the second ends of the support arms; and
an axle extending across the support arms intermediate the first and second ends thereof and rotatably supporting a wheel resting a distance above the ground on which the foot scooter rests, the axle being configured to be removable from the support arms for interchanging the wheel;
whereupon downward pressure on the foot bar, a front end of the scooter raises off the ground and the wheel contacts the ground to permit a rider of the foot scooter to perform tricks.

19. The trick bar of claim 18, wherein the support arms include a series of apertures which permit the axle to be moved between positions along the support arms.

20. The trick bar of claim 18, wherein the support arms include reinforcement areas substantially surrounding the axle.

21. The trick bar of claim 18, wherein the axle supports a wheel positioned between the support arms.

22. The trick bar of claim 18, wherein the axle extends beyond the support arms and supports two wheels positioned without the support arms.
